(19) United States
(12) Patent Application Publication
(10) Pub. No.: US 2005/0071347 A1
(43) Pub. Date: Mar. 31, 2005

(54) System and method for conversion between graph-based representations and structural text-based representations of business processes

(75) Inventors: Tony Chau, Scarborough (CA); Lok Loi, Toronto (CA); Kelly M. Lalonde, Toronto (CA)

Correspondence Address: Leslie A. Van Leeuwen;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/803,675

(22) Filed: Mar. 18, 2004

(30) Foreign Application Priority Data
Sep. 30, 2003 (CA) 2443447

(51) Int. Cl. G06F 7/00

(52) U.S. Cl. 707/100

(57) ABSTRACT

Conversion between graphical representations and structural text-based representations of business process. A set of identifiable features and associated pattern mappings is defined. Graphical representations are converted by identifying features and referring to associated pattern mappings to define an equivalent structural text-based representation. Appropriate structural text-based representations are converted by determining features for the graphical representations based on the associated pattern mappings that are determined to correspond to the structural text-based representations.

### FIELD OF THE INVENTION

The present invention relates generally to computer systems and more specifically to a system and method for conversion between graph-based representations and structural text-based business process representations.

### BACKGROUND OF THE INVENTION

A business process includes a defined set of actions taken in the course of conducting business. Through the use of computer systems, business processes can be automated. An automated business process typically requires input and generates output. A business process may be a single task or a complicated procedure such as a procedure for building a product. An example of a more complicated computer-implemented business process is a business transaction against a database for the purchase of goods on the Internet. The term “business process” also includes other processes that are related to a business context in a broad sense—for example a process used to manage donor lists for a charity is referred to as a “business” process although it relates to a charitable activity and not a business activity as narrowly defined. For all business processes, but in particular for automated business processes, it is potentially advantageous to document the processes using a computer-implemented representation. Often business processes are graphically represented in a computer-implemented system using a visual representation.

Computer software such as the WebSphere™ Studio Application Developer Integration Edition (WSADIE) process tool distributed by IBM Corporation allows users to visually represent a business process as a graph having features defined by node, terminal and connection elements. Connection elements connect nodes as in a directed graph and provide a flow that is apparent in the visual representation and which is intended to represent the relationships between activities in business processes. In a graphical representation that is used to control a business process, control over the process is transferred from node to node as the connection elements are followed.

Alternatively, business processes may be represented in a computer system textually using a structural computer language, such as Business Process Execution Language for Web Services (BPEL4WS). BPEL4WS is used to describe business processes and is based on Extensible Markup Language (XML) specifications. BPEL4WS allows for text-based business process representations having a structure of hierarchical nested elements.

It is often desirable to convert a representation of a business process from a graphical to a structural text-based representation, or vice versa. However, such conversions present difficulties. For example, different programmers charged with the task of converting a graphical representation of a business process to a text-based representation may apply different approaches to determine equivalent representations for graphical representations where control is transferred from one element to the next. Consequently, different structural text-based representations of the same graphical representation of a business process may be dissimilar, particularly where the graphical representation of the business process is marked by sophisticated flow logic. Despite the convenience of using a graphical representation to describe a business process, it becomes less desirable if it is intended to be shared among several users who may convert the features of the graphical representation differently. Different conversions may use the structural elements available in the text-based representations to varying degrees. Typically, the use of structural elements in the text-based representation aids in readability of the representation.

Furthermore, in some cases structural text-based representations derived from a graphical representation of a business process may be converted back to a graphical form. If the original conversion to the text-based representation is not carried out in a manner that preserves the semantics of the graphical representation as much as possible, after the re-conversion to the graphical representation form the business processes represented by the representations (the original graphical representation and the re-converted version derived from the text-based representation) may not be identical. This lack of consistency may decrease the accuracy of computer-implemented representations of the business process.

Various components or characteristics of the business process may be expressed in more than one computer language or format, such as XML and Java. While it is known to provide a process for mapping an XML document to Java, as suggested in the white paper published by Collaxa, Collaxa WSOS 2.0: An Introduction, the prior art does not disclose a method of mapping business process features from a graphical representation to a structural, text-based representation that preserves the flow logic of the business process structure.

Accordingly, it is desirable to convert graphical representations of a business process to a structural, text-based computer language representation, where the logic and features are converted in a correct and consistent manner and where the conversion from the text-based to graphical representation is also supported.

### SUMMARY OF THE INVENTION

The present invention provides a system and method for converting from graphical representations to structural text-based language representations of business processes. In a conversion carried out in accordance with one aspect of the invention, a graphical representation is analyzed in comparison with a set of defined features. An associated pattern mapping is defined for each feature in the set, and the appropriate mapping is used in the conversion to a structural text-based representation. The present invention also provides a system and method for converting from structural text-based representations of business processes to graphical representations.

In the preferred embodiment, an aspect of the present invention can be used to export a business process built using the WSADIE process tool and having features corresponding to a set of generally accepted features to a BPEL4WS representation, and can also be used to import a business process represented in BPELAWS having features corresponding to a defined set of patterns for conversion into the WSADIE process tool.

An advantage of an aspect of the present invention is the ability to obtain consistent and repeatable conversions from graphical representations to structural text-based representations of business processes. The structural text-based representations resulting from such conversions are also capable of re-conversion to equivalent graphical representations.

Another advantage of an aspect of the present invention is the readability of the exported structural text-based language representation resulting from the use of structural elements promoted in the conversion to a text-based representation carried out in accordance with the invention.

Accordingly, an aspect of the invention provides a computer program product for converting between graphical and structural text-based representations of business processes, having program code for storing and maintaining a set of features identifiable in graphical business process representations, each feature in the set of features having an associated pattern mapping defined relative to structural text-based representations; identifying portions of an initial graphical representation as matching features in the set of features; generating structural text-based representations of the identified portions of the initial graphical representation by applying the pattern mappings associated with the matching features to the identified portions of the graph-based representation; identifying portions of an initial structural text-based representation of a business process as corresponding to pattern mappings associated with features in the set of features; and generating graphical representations of the identified portions of the initial structural text-based representation by reference to the features associated with the pattern mappings corresponding to the identified portions of the initial structural text-based representation. An aspect of the invention further provides a set of identifiable features stored and maintained in the program code consisting of features selected from: synchronous and asynchronous processes, request/response activities, one-way activities, empty nodes, blocks, iterations, receive events, compensation, correlation, variables, fault handling and transition conditions.

A further aspect of the invention provides a set of identifiable features and associated pattern mappings consisting of feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <on Message> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationSet> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
   (a) if thrown internally: a <throw> activity; or
   (b) if thrown externally: a <reply> activity; and
xii. feature: transition condition; pattern mapping: an attribute in a <source> element of a <link> element representing the transition.

A further aspect of the invention provides an import and export tool for exporting from graphical representations of business processes to structural text-based representations and for importing from structural text-based representations of business processes to graphical representations, comprising storage and maintenance code for implementing the storage and maintenance of a set of features identifiable in graphical business process representations, each feature in the set of features having an associated pattern mapping defined relative to structural text-based representations, graph identification code for identifying portions of an initial graphical representation as matching features in the set of features, export generation code for generating structural text-based representations of the identified portions of the initial graphical representation by applying the pattern mappings associated with the matching features to the identified portions of the graph-based representation, import identification code for identifying portions of an initial structural text-based representation of a business process as corresponding to pattern mappings associated with features in the set of features, and import generation code for generating graphical representations of the identified portions of the initial structural text-based representation by reference to the features associated with the pattern mappings corresponding to the identified portions of the initial structural text-based representation. An aspect of the invention further provides that this import and export tool uses a set of identifiable features and associated pattern mappings consisting of feature and pattern mapping pairs selected from set of pairs itemized above.

Another aspect of the invention provides a computer program product for converting from a graphical to a structural text-based representation of business processes with code for storing and maintaining a set of features identifiable in graphical business process representations, each feature in the set of features having an associated pattern mapping defined relative to structural text-based representations, identifying portions of an initial graphical representation as matching features in the set of features, and generating structural text-based representations of the identified portions of the initial graphical representation by applying the pattern mappings associated with the matching features to the identified portions of the graph-based representation. A further aspect of the invention provides code for extracting properties from graphical elements in the identified portions of the initial graph-based representation and defining corresponding attributes for elements in the generated structural text based representations. Still a further aspect provides code using a set of identifiable features selected from the list of features provided above, and a set of identifiable features and associated pattern mappings selected from the set of pairs of features and mappings itemized above.

A further aspect of the invention provides an export tool for exporting from graphical representations of business processes to structural text-based representations, consisting of storage and maintenance code for implementing the storage and maintenance of a set of features identifiable in graphical business process representations, each feature in the set of features having an associated pattern mapping defined relative to structural text-based representations, graph identification code for identifying portions of an initial graphical representation as matching features in the set of features, and export generation code for generating structural text-based representations of the identified portions of the initial graphical representation by applying the pattern mappings associated with the matching features to the identified portions of the graph-based representation, with a set of identifiable features selected from: synchronous and asynchronous processes, request/response activities, one-way activities, empty nodes, blocks, iterations, receive events, compensation, correlation, variables, fault handling and transition conditions. Still a further aspect of the invention provides an export tool using a set of identifiable features and associated pattern mappings from the set of pairs itemized above.

A further aspect of the invention provides an import tool for importing from structural text-based representations of business processes to graphical representations, comprising storage and maintenance code for implementing the storage and maintenance of a set of features identifiable in graphical business process representations, each feature in the set of features having an associated pattern mapping defined relative to structural text-based representations, import identification code for identifying portions of an initial structural text-based representation of a business process as corresponding to pattern mappings associated with features in the set of features, and import generation code for generating graphical representations of the identified portions of the initial structural text-based representation by reference to the features associated with the pattern mappings corresponding to the identified portions of the initial structural text-based representation. An aspect of the invention further provides an import tool using a set of identifiable features and associated pattern mappings consisting of feature and pattern mapping pairs selected from set of pairs itemized above.

An aspect of the invention further provides that the code includes means for converting Java code referenced in the initial graphical representation, specifically Java snippet nodes, and Java assignment and condition expressions, to XPath code in the generated structural text-based representation.

A further aspect of the invention provides that the initial graphical representation is compatible with the Web Sphere™ Studio Application Developer Integration Edition platform and that the generated structural text-based representation is compatible with the Business Process Execution Language for Web Services platform.

An aspect of the invention provides a method for converting from graphical to structural text-based representations of business processes with the steps of: defining and maintaining a data representation of a set of features identifiable in graphical business process representations, each feature in the set of features having an associated pattern mapping defined relative to structural text-based representations, identifying portions of an initial graphical representation matching features in the set of features, and generating structural text-based representations of the identified portions of the initial graphical representation by applying the pattern mappings associated with the matching features to the identified portions of the graph-based representation, where the set of identifiable features is selected from: synchronous and asynchronous processes, request/response activities, one-way activities, empty nodes, blocks, iterations, receive events, compensation, correlation, variables, fault handling and transition conditions. A further aspect of the invention provides a method for converting from graphical to structural text-based representations of business processes where the set of identifiable features and associated pattern mappings is selected from the set of pairs itemized above. Still a further aspect of the invention provides a conversion method in which the step of generating structural text-based representations of the identified portions of the initial graph-based representation further comprises the steps of converting Java code referenced in the initial graphical representation, specifically Java snippet nodes and Java assignment and condition expressions, to XPath code in the generated structural text-based representation, and the initial graphical representation is compatible with the Web Sphere™ Studio Application Developer Integration Edition platform and the generated structural text-based representation is compatible with the Business Process Execution Language for Web Services platform. In a further aspect of the invention, a computer program product is provided for accomplishing the above method, either on a recordable data storage medium or in a modulated carrier signal transmitted over a network such as the Internet.

### BRIEF DESCRIPTION OF THE DRAWINGS

In drawings which illustrate by way of example only a preferred embodiment of the invention,

FIG. 1 is a block diagram illustrating a high level description of the preferred embodiment.

FIG. 2a illustrates a graphical representation of a business process that shows a simple synchronous process.

FIG. 2b illustrates a graphical representation of a business process that shows a simple asynchronous process.

FIG. 3 illustrates a graphical representation of a business process that shows a simple process having an empty node and a Java snippet node.

FIG. 4a illustrates a graphical representation of a business process that shows the contents of the body of a simple block.

FIG. 4b illustrates a graphical representation of a business process that shows a block having the block body shown in FIG. 4a.

FIG. 5a illustrates a graphical representation of a business process that shows the contents of the body of a simple loop.

FIG. 5b illustrates a graphical representation of a business process that shows a loop having the loop body shown in FIG. 5a.

FIG. 6 illustrates a graphical representation of a business process that shows a pick process.

FIG. 7 illustrates a graphical representation of a business process that shows a simple process having a service node that has a compensation service.

FIG. 8 illustrates a graphical representation of a business process that shows a simple process having a receive event node.

FIG. 9 illustrates a graphical representation of a business process with a fault terminal.

FIG. 10 illustrates a graphical representation of a block body in a business process having a fault terminal.

FIG. 11 illustrates a graphical representation of a business process that shows a process having a block node, the body of the block being as shown in FIG. 10.

FIG. 12 illustrates a graphical representation of a loop body in a business process having a fault terminal.

FIG. 13 illustrates a graphical representation of a business process that shows a process having a loop node, the body of the loop being as shown in FIG. 12.

FIG. 14 illustrates a graphical representation of a business process that shows a simple process that contains multiple control connections with conditions set on the connections.

FIG. 15 illustrates a graphical representation of a business process that shows a process having a node with a fault terminal where the fault terminal has outgoing control connections to two different nodes.

FIG. 16 is a graphical representation of a business process that contains multiple Java snippet nodes with assignment code set on the nodes.

FIG. 17 illustrates a graphical representation of a business process that has multiple links with conditions set on the links.

### DETAILED DESCRIPTION OF THE INVENTION

The preferred embodiment is described with reference to graphical representations of business processes defined using the WSADIE version 5 process tool and structural text-based representations using the BPEL4WS business process language. It will be understood by those skilled in the art that the system and method of the preferred embodiment may be carried out with reference to representations made using other tools for creating graphical representations of business processes or other business process languages that similarly define the structure of a business process in a hierarchy of nested elements.

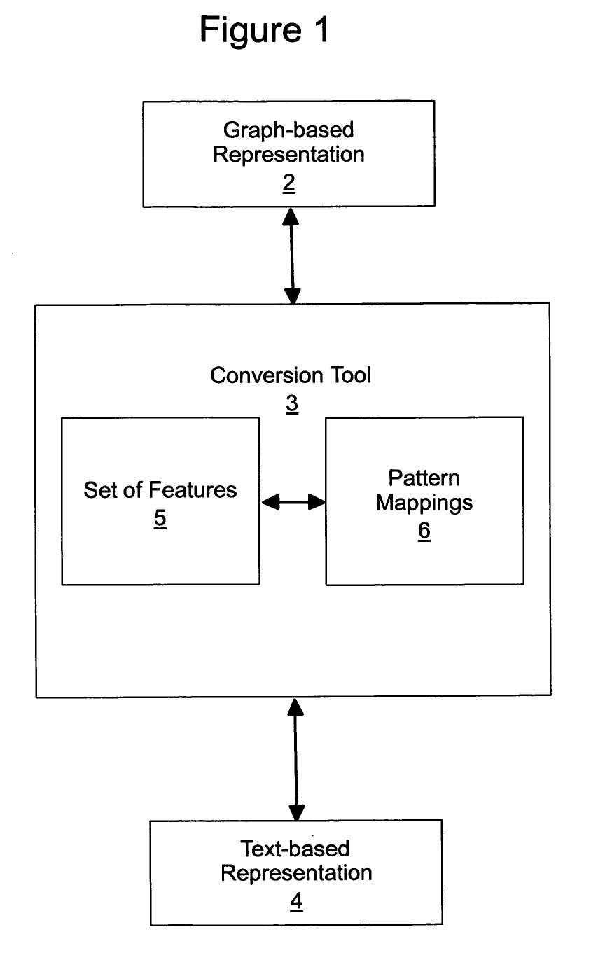

FIG. 1 shows, in a block diagram, high-level components in the system of the preferred embodiment. Graph-based representation 2 is shown as being either input to, or output from, conversion tool 3. Similarly, text-based representation 4 is shown as being alternatively input to, or output from, conversion tool 3. Conversion tool 3 is shown referencing set of features 5 and pattern mappings 6. Each of these are representations of feature information and pattern mapping information and which may be implemented in different ways for use by conversion tool 3. Set of features 5 has associated pattern mappings 6 and the interrelationship between the two representations is shown by the arrow between the two blocks in FIG. 1. As is described in more detail below, conversion tool 3 accesses set of features 5 and associated pattern mappings 6, to carry out conversions between graph-based representation 2 and structural text-based representation 4.

In the preferred embodiment, the set of identifiable features that may be mapped between the graphical and structural text-based business process representations (set of features 5 in FIG. 1), consist of the following (for ease of reference, conventional BPEL4WS terminology is used to describe the features):
(1) synchronous and asynchronous processes;
(2) request/response activities;
(3) one-way activities;
(4) empty nodes;
(5) blocks;
(6) iterations;
(7) receive event (ability to wait for events to select a path of execution based on the event received);
(8) compensation;
(9) correlation;
(10) variables;
(11) fault handling; and
(12) transition conditions.

A conversion from a representation of one type to that of the other may involve simple one-to-one mappings, or more complex mapping operations. When converting from a graphical representation to a structural text-based representation, elements in the graphical representation are mapped to corresponding elements in the structural text-based representation. Properties of the graphical element are extracted and saved as attributes of its corresponding element in the structural text-based representation. In the description below, mapping from a graphical representation to a structural text-based representation (from graphical representation 2 to structural text-based representation 5) is referred to as “exporting” a process. An “exporter” is preferably a software tool that exports a process according to the preferred embodiment (in the example of FIG. 1, conversion tool 3 is capable of acting as an exporter).

When converting from a structural text-based representation to a graphical representation, elements in the structural text-based representation, except for structural features that are used to define sequential or concurrent flow or synchronization in the business process, are mapped to appropriate node elements according to the pattern mappings for conversion. Attributes of elements in the structural text-based representation are converted to the appropriate properties of the corresponding graphical node elements. The layout of the graphical representation can be constructed by examining the structural elements in the structural text-based representation. In the description below, mapping from a structural text-based representation to a graphical representation is referred to as “importing” a process. An “importer” is preferably a software tool that imports a process according to the preferred embodiment (in the simple example of FIG. 1, conversion tool 3 functions as both an importer and an exporter).

As will be apparent from the description set out below, business process graphs are defined using graphical elements including node, terminal and connection elements. The method and system of the preferred embodiment is capable of converting such graphs to an appropriate structural text-based representation. The method and system may also be used to convert from certain structural text-based representations to a graphical representation, where such text-based representations meet criteria set out in more detail below.

According to the preferred embodiment, an exporter process first identifies the features of the business process represented in the graphical representation to be converted. In the preferred embodiment, the set of features listed above is used (set of features 5 in FIG. 1) and the exporter process identifies the properties associated with each identified feature in the graphical representation. The exporter is able to access a set of pattern mappings corresponding to the set of possible identified features. The pattern mappings correlate the graphical representation of each feature to a structural text-based representation.

After identification, the portions of the graphical representation having features in the feature set are converted to corresponding structural text-based representations using the appropriate pattern mappings, while preserving the associated properties of each portion of the graphical representation. The flow logic of the business process may then be constructed in the structural text-based representation by linking the text-based representations in a manner that will be understood by those skilled in the relevant art. For example, to connect text-based representations corresponding to nodes in the graph being converted, the BPEL4WS link construct may be used.

Using the approach of the preferred embodiment, a complete structural text-based representation equivalent to the graphical representation of the business process may be built. According to the preferred embodiment, the different identifiable features referred to above, and a description of their associated pattern mappings, are set out below, with simple examples provided by way of illustration.

(1) Synchronous and Asynchronous Processes: In graphical representations defined using the WSADIE process tool of the preferred embodiment, a synchronous process is modelled by a request/response interface. A caller invokes this operation to run the process. The result of the process is then returned to the caller immediately via this request/response operation.

When a synchronous process feature is identified in a representation in the graph-based process tool, access is made to the associated pattern mapping. The pattern mapping includes a text-based (BPEL4WS) representation having <receive> and <reply> activities as its interface. The <receive> activity represents the input interface of the synchronous process in the graphical representation. The <reply> activity represents the output interface of the synchronous process. In the case of a synchronous process, the <reply> activity usually returns the result shortly after the process is invoked.

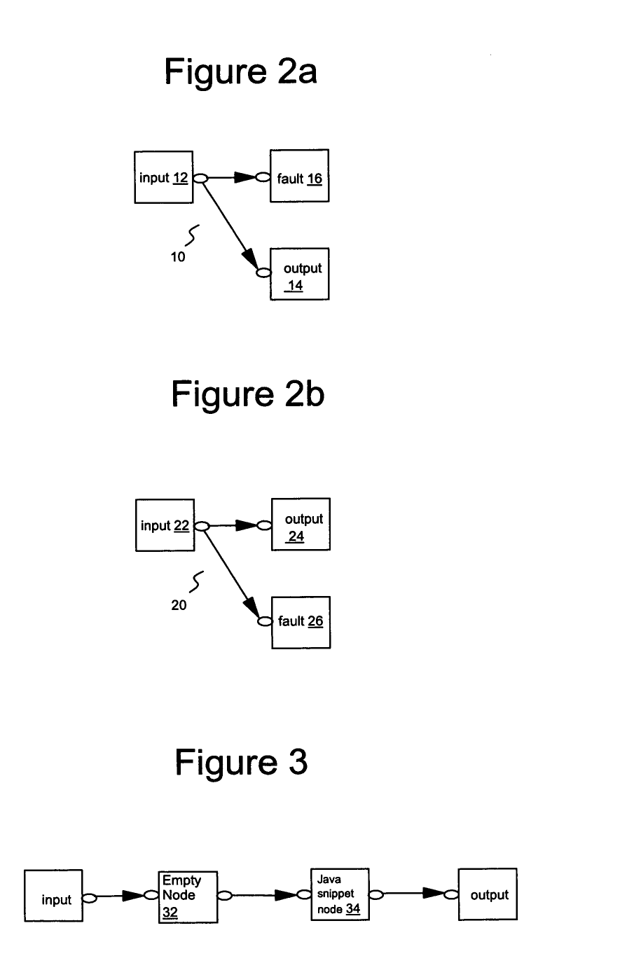

FIG. 2a illustrates a simple synchronous process displayed in the graph-based process tool of the preferred embodiment. The synchronous process 10 defined has an input node 12, an output node 14 and a fault node 16.

The example synchronous process of FIG. 2a is mapped to a structural text-based representation in accordance with the pattern mapping referred to above. For the example given, an example equivalent text-based (BPEL4WS) representation that may be generated by applying the pattern mapping is the following segment:

<!-- from BPEL4WS file -->
<sequence>

<receive container=“input” createInstance=“yes”
operation=“VVVOp”
portType=“ns2:VVVPortType”/>
<flow>

<reply container=“vVVFaultMsg”
faultName=“ns2:VVVFaultMsg”
name=“Fault” operation=“VVVOp”
portType=“ns2:VVVPortType”/>
<reply container=“output” operation=“VVVOp”
portType=“ns2:VVVPortType”/>

</flow>
</sequence>

In accordance with the preferred embodiment and the pattern mapping defined as set out above, the <receive> activity in the BPEL4WS fragment represents the input node 12 from the graph-based representation of FIG. 2a. In the preferred embodiment, the <receive> activity preferably has operation and portType attributes which identify the interface of the process. Further, the output node 14 is represented by a <reply> activity without a faultName attribute. The <reply> with faultName=“ns2:VVVFaultMsg” represents the fault node 16. With respect to the reverse conversion, an importer interprets <reply> activities in the text-based representation as output nodes unless there is a faultName attribute specified. The faultName attribute corresponds to the qualified message type of the container set on the fault node. The name attribute corresponds to the name of the node.

Exporting a process to BPEL4WS requires variables to be assigned to input and output nodes as this corresponds with the BPEL4WS specification requirement of requiring containers defined and referenced for <receive> and <reply> activities. On export, the createinstance attribute is always set to yes on the <receive> activity, as this starts off the process.

As the above explanation and example indicate, where there is an identification of a feature in a graph-based representation that is synchronous, a BPEL4WS text-based representation may be determined by using the pattern mapping that is defined for such a synchronous process feature.

The same type of approach may be applied for graph-based representations that include an asynchronous process. An asynchronous process is generally a long-running process. In the graphical process tool, such an asynchronous process is modelled by a one-way interface: a caller process invokes the asynchronous process through this one-way interface. The result is returned to the caller process by invoking a callback operation, which is another one-way operation. The input interface is represented by an input node in the process tool. The output interface is represented by an output node in the process tool.

The pattern mapping for an asynchronous process in the graphical process tool is provided by a BPEL4WS process with <receive> and <invoke> activities as its interface. The <receive> activity represents the input interface of the asynchronous process. The <invoke> activity represents the output interface of the asynchronous process. This activity returns the result by invoking a service provided by the caller, which is equivalent to the property of an asynchronous process built with the process tool.

FIG. 2b illustrates a simple example asynchronous process as displayed in the graph-based process tool. For the asynchronous process 20, the input node 22, the output node 24 and the fault node 26 each use a different one-way interface.

The asynchronous process shown in FIG. 2b may be converted to a structural text-based representation, using the pattern mapping described above, in accordance with the following example segment:

<!-- from BPEL4WS file -->
<sequence>

<receive container=“input” createInstance=“yes”
operation=“YYYOp”
portType=“ns2:YYYPortType”/>
<flow>

<invoke inputContainer=“output” name=“Output_Output1”
operation=“ZZZOneWayOp” portType=“ns4:ZZZPortType”/>
<invoke inputContainer=“eEEInputMsg” name=“Fault_Fault1”
operation=“EEEOp” portType=“ns3:EEEPortType”/>

</flow>

</sequence>

In the equivalent BPEL4WS representation, a <receive> activity represents the input node 22. An<invoke> activity with the following naming convention represents an output node such as output node 24 in FIG. 2b:
name=“Output_”+[Name of Output Node]
where the name prefixed by “Output_” identifies the <invoke> as an output node.

An<invoke> activity with the following naming convention represents a fault node such as the fault node 26:
name=“Fault_”+[Name of Fault Node]
where the name prefixed by “Fault_” identifies the <invoke> as a fault node.

The operation and portType attributes of an <invoke> activity identify the operation that will be invoked by the process, in order to return results to the appropriate process instance.

In the graphical representation, whether a process is synchronous or asynchronous cannot be ascertained solely from viewing the graphical representation. A property that is associated with a graphical representation component in the graphical representation indicates whether a given process is synchronous or asynchronous. Hence the term “graphical representation” is used to describe the combination of graphical representation components and the properties associated with graphical representation components.

(2) Request/Response Activities: Request/response activities are identifiable features in graphical representations of business processes. In general, request/response activities are represented by service nodes in the graphical representations of the preferred embodiment. These service nodes take input from, and return an output to, the process. Both the input and output are variables in the process. Variables must be assigned to the service node to specify the input and output parameters.

When a request/response activity feature is identified, the exporter accesses the corresponding pattern mapping. In the preferred embodiment, the pattern mapping defines the corresponding BPEL4WS element to be an <invoke> activity, which is used to invoke an operation. An <invoke> activity has attributes inputContainer and outputContainer to specify the input and output containers assigned to this activity.

An example of BPEL4WS for an <invoke> with a request-response operation is:

<!-- from BPEL4WS file -->
<invoke inputContainer=“rRRInputMsg” name=“RRROp”
operation=“RRROp”
outputContainer=“rRROutputMsg” portType=“ns3:RRRPortType”/>

The mapping involves converting the request/response activity to an <invoke> activity. The attributes inputContainer and outputContainer reference the containers used by this <invoke> activity.

Where request-response operations on service nodes are represented in BPEL4WS, the name attribute of the <invoke> activity is the name of the service node. The inputContainer and outputContainer attributes are mapped to containers created for the variables assigned to the input and output terminals of the service node. The portType and operation attributes correspond to the port type and operation set on the service node. These attributes define which operation the process will invoke.

(3) One-way Activities: Like request/response activities, one-way activities are represented by service nodes in the process tool. However, one-way activities only take an input parameter and return nothing to the process. Users must only assign an input variable to the service node representing a one-way operation.

When a one-way activity is identified, the exporter accesses the corresponding pattern mapping. In the preferred embodiment, the appropriate pattern mapping is an <invoke> activity.

An example of BPEL4WS for <invoke> activities specifying one-way operations is:

<!-- from BPEL4WS file -->
<invoke inputContainer=“yYYInputMsg” name=“YYYOp”
operation=“YYYOp”
portType=“ns3:YYYPortType”/>

The mapping is similar to mapping of request/response activity; however, there is no attribute outputContainer because no output variable is assigned to the corresponding service node.

Where one-way operations on service nodes are represented in BPEL4WS, the name attribute of the <invoke> activity is the name of the service node. The inputContainer attribute is mapped to a container created for the variable assigned to the input of the service node. There is no outputContainer attribute, since one-way operation does not return anything as output. The portType and operation attributes correspond to the port type and operation set on the service node. These attributes define which operation the process will invoke.

(4) Empty Nodes: An empty node does not correspond to any operation execution, but it provides a visual joint point. It also serves other purposes as detailed in the sections dealing with blocks and loops, below.

FIG. 3 illustrates a graphical representation of a simple process containing an empty node 32 (FIG. 3 also shows Java snippet node 34, described in more detail below).

When an empty node is identified in a graphical representation, the exporter maps the feature to a pattern mapping with an <empty> activity. In the preferred embodiment, the activity uses the following naming convention:
name=“Empty_”+[Name of node]

With respect to conversions from text-based to graphical representations, in the preferred embodiment, only <empty> activities with this naming convention are imported as empty nodes. Conversely, empty nodes are exported with this naming convention. In the preferred embodiment, <empty> activities that do not correspond to empty nodes in a graphical representation are used as placeholders in some BPEL4WS mappings. Similarly, these placeholder <empty> activities are defined using specific naming conventions.

(5) Blocks: A block node collects elements together as a distinct subset of the process. In the process tool, the block body must contain both input and output nodes as the start and end of the flow in the block node.

When a block node is identified, the pattern mapping applied by the exporter groups a subset of connected activities together as one distinct portion in the business process, which may be interpreted as a sub-routine. In the preferred embodiment, the mapping includes a <scope> activity.

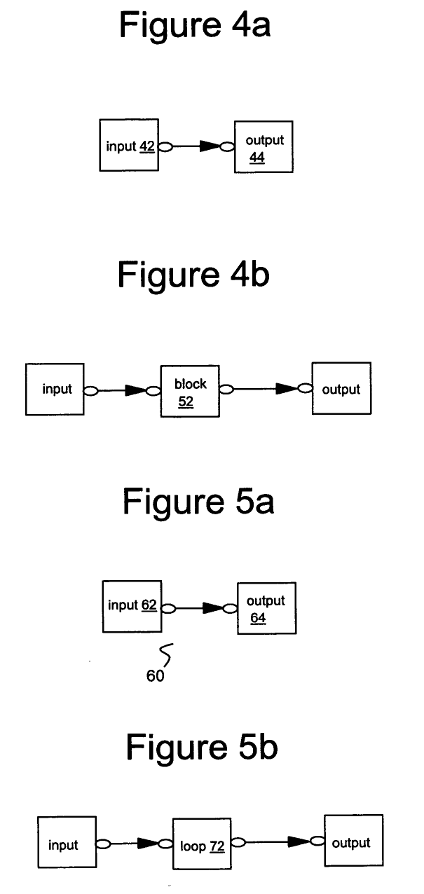

FIG. 4a illustrates the contents of the body of a simple block, as it would be displayed in the process tool. FIG. 4b illustrates a block in a process in this example, the block having the block body shown in the FIG. 4a.

The block shown in FIG. 4a may be mapped to a structural text-based representation in accordance with the following segment:

<!-- from BPEL4WS file -->
<scope containerAccessSerializable=“no” name=“Block”>

<sequence>

<empty name=“Input_Input1”/>
<empty name=“Output_Output1”/>

</sequence>

</scope>

The process shown in FIG. 4b may be mapped to a structural text-based representation in accordance with the following segment:

<!-- from BPEL4WS file -->
<sequence>

<receive container=“input” createInstance=“yes”
operation=“RRROp”
portType=“ns2:RRRPortType”/>
<scope containerAccessSerializable=“no” name=“Block”>

<sequence>

<empty name=“Input_Input1”/>
<empty name=“Output_Output1”/>

</sequence>

</scope>
<reply container=“output” operation=“RRROp”
portType=“ns2:RRRPortType”/>

</sequence>

Hence the mapping involves converting a block node to a <scope> activity. All elements in the block body are converted according to the mappings described in the preferred embodiment. The resulting structures are nested within the <scope> activity. To make both representations equivalent, two <empty> activities are nested within the <scope> activity to represent the mandatory input and output nodes in the block body.

A<scope> activity represents a block node such as the block node 52 and has the following pattern:
name=[Name of the block node]

A <scope> activity must contain a <flow> or a <sequence> activity. A <scope> activity must contain placeholders for the input node 42 and the output node 44 in the block.

An empty activity with the following pattern is a placeholder for the input node 42:
name=“Input_”+[Name of Input node]

An empty activity with the following pattern is a placeholder for the output node 44:
name=“Output_”+[Name of Output node]

These empty nodes are created in the structural text-based representation so that the representation can be equivalent in structure to the original graphical representation. The attribute containerAccessSerializable has a default value of no. Other nodes inside a block are represented in the equivalent BPEL4WS representation as defined in this description of the preferred embodiment.

(6) Iterations: Iterations are represented by loop nodes in the graphical representations of the preferred embodiment. A loop condition must be set on the node to determine under what condition this loop node should execute. If the loop condition evaluates to true, the loop node continues to execute any activities in its body. The loop body contains elements that run repeatedly as long as the condition is true. In the process tool, the loop body must contain both input and output nodes to represent the start and end of the flow in the loop node.

When an iteration is identified by the exporter, the pattern mapping corresponding to iterations is accessed to convert the iteration to a structural, text-based language representation. In the preferred embodiment, iterations are represented by <while> activities. A <while> activity has an attribute condition expressed in XPath, which determines when the <while> activity should execute.

FIG. 5a illustrates the contents of the body of a simple loop, as it would be displayed in the process tool. FIG. 5b illustrates loop node 72 in a process, the loop having the loop body shown in FIG. 5a.

An example of the conversion of a loop node such that shown in FIG. 5b is shown the following BPLE4WS segment:

<!-- from BPEL4WS file -->
<while condition=“getInput( ) != null” name=“Loop”>

<sequence>

<empty name=“Input_Input1”/>
<empty name=“Output_Output1”/>

</sequence>

</while>

The process shown in FIG. 5b may be mapped to a structural text-based representation in accordance with the following segment:

<!-- from BPEL4WS file -->
<sequence>

<receive container=“input” createInstance=“yes”
operation=“RRROp”
portType=“ns2:RRRPortType”/>
<while condition=“getInput( ) != null” name=“Loop”>

<sequence>

<empty name=“Input_Input1”/>
<empty name=“Output_Output1”/>

</sequence>

</while>
<reply container=“output” operation=“RRROp”
portType=“ns2:RRRPortType”/>

</sequence>

The mapping involves converting the loop node to a <while> activity. All elements in the loop body are mapped to the appropriate activities according to the mappings of the preferred embodiment and nested within the <while> activity. Any activities nested within the <while> activities run repeatedly as long as the condition is true. To make both representations equivalent, two <empty> activities are nested within the <while> activity to represent the mandatory input and output nodes in the loop body.

A <while> activity represents a loop node such as the loop node 72 and has the following pattern:

name = [Name of the loop node]
condition = [boolean expression in Java]

The <while> activity must contain a <flow> or a <sequence> activity and placeholders for input node 62 and output node 64 in loop 60. For the while condition, boolean expressions must be placed in quotes. The BPEL4WS while condition represents the “if” condition in the loopCondition method for the loop 60.

An empty activity with the following pattern is a placeholder for input node 62:
name=“Input_”+[Name of Input node]

An empty activity with the following pattern is a placeholder for output node 64:
name=“Output_”+[Name of Output node]

These empty activities are created in the structural text-based representation so that the representation can be equivalent in structure to the original graphical representation.

In the preferred embodiment of the importer and exporter, the code must follow a certain format, illustrated below, for the exporter to extract the condition correctly. On import, this format is generated and the BPEL4WS “while” condition is inserted into the “if” statement. The code on import is also surrounded by a try/catch block to avoid any unhandled exceptions that might be thrown by the Java condition. For example:

public Boolean loopCondition_FlowNode_2( )|

throws com.ibm.bpe.api.ProcessException {
boolean result = true;
// user code begin {Loop block Expression}
try {

if(getInput( ) != null)

result = true;

else

result = false;

}
catch(Exception e) { }
// user code end
return result;

}

(7) Receive Event (ability to wait for events to select a path of execution based on the event received): In the graph-based representations of the process tool this feature is represented by a receive event node. Receive event nodes wait for an event and select a path of execution depending on the event received. Events are specified by one-way operations in the process tool, which are shown graphically as out terminals on the receive event node. An event occurs when the one-way operation that specifies the event is invoked.

When this feature is identified in a graphical representation, the exporter accesses the associated pattern mapping. In the preferred embodiment, the receive event node feature in the graphical representation is associated with a pattern mapping to a BPEL4WS <pick> activity.

A <pick> activity contains several <on Message> structures. Each <on Message> defines an event that the <pick> activity accepts. It also specifies the path of execution if this event is received. All events defined in the receive event node are converted to <on Message> structures. These structures are then nested within the <pick> activity. All elements in the path of execution are converted according to the mappings described in this invention. The resulting structure is nested within the corresponding <on Message> structure to indicate the path to be executed when that event is received.

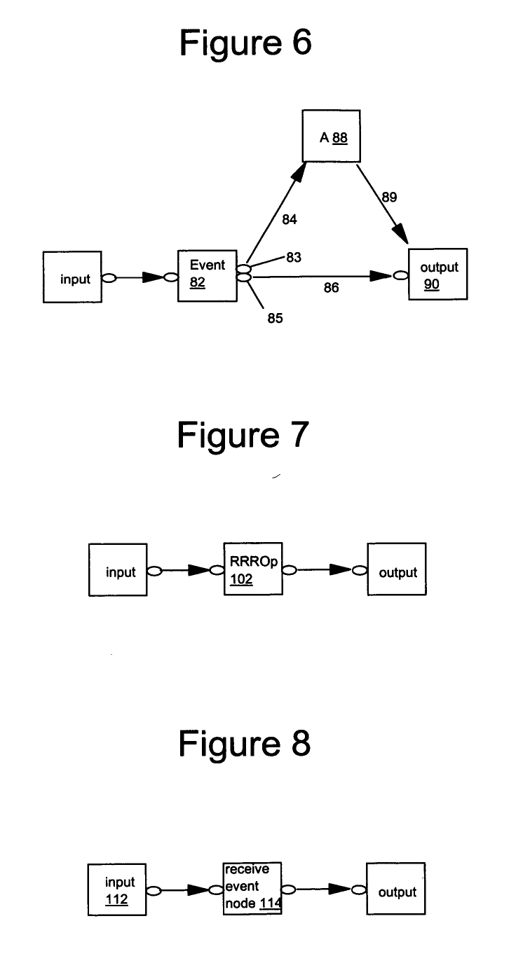

FIG. 6 illustrates a simple example process having a receive event node, as it may be displayed in a graphical representation.

An example of how the process defined in the graphical representation of FIG. 6 may be mapped to a structural text-based representation is shown in accordance with the following example segment, based on the pattern mapping:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3”/>

</links>
<receive container=“input” createInstance=“yes” operation=“YYYOp”
portType=“ns2:YYYPortType”>

<source linkName=“FlowConditionalControlConnection_1”/>

</receive>
<pick createInstance=“no” name=“Pick”>

<target linkName=“FlowConditionalControlConnection_1”/>

<onMessage container=“eEEInputMsg” operation=“EEEOp”
portType=“ns3:EEEPortType”>

<invoke inputContainer=“rRRInputMsg” name=“A” operation=“RRROp”
outputContainer=“rRROutputMsg” portType=“ns5:RRRPortType”>

<source linkName=“FlowConditionalControlConnection_2”/>

</invoke>

</onMessage>
<onMessage container=“dDDInputMsg” operation=“DDDOp”
portType=“ns4:DDDPortType”>

<empty>

<source linkName=“FlowConditionalControlConnection_3”/>

</empty>

</onMessage>

</pick>

<invoke inputContainer=“output” name=“Output_Output”
operation=“CCCOneWayOp” portType=“ns6:CCCPortType”>

<target linkName=“FlowConditionalControlConnection_2”/>
<target linkName=“FlowConditionalControlConnection_3”/>

</invoke>

</flow>

In FIG. 6, the paths indicated by control connections 84, 86 that connect to out terminals 83, 85 on receive event node 82, respectively, define the path of execution if the event represented by one of out terminals 83, 85 is received. In the equivalent BPEL4WS representation, the <pick> activity corresponds to receive event node 82. The <onMessage> structures correspond to out terminals 83, 85 on receive event node 82. The paths indicated by the control connections 84, 86 from out terminals 83, 85 of receive event node 82 are captured in the corresponding <onMessage> structures. The operation and portType attributes of the <onMessage> structure define the event that receives event node 82 responds.

Out terminal 83 is connected to node A 88, which in turn is connected to output node 90. This is represented by the first <onMessage> structure, which has <invoke> activity A embedded in it. Out terminal 85 is connected to output node 90 only. The second <onMessage> structure has an <empty> activity placeholder embedded to mark the source of the link to the output. This link represents control connection 86 from out terminal 85 of receive event node pick 82 to output node 90. When creating receive event nodes in the process tool, variables for each event must be set in order to export correctly because BPEL4WS requires <onMessage> to have a container defined. On export, the createInstance attribute is always set to no on the <pick> activity, as this does not start off the process.

(8) Compensation: In the graphical representation described with reference to the preferred embodiment, compensation is achieved using service nodes. The compensation activity will run if the execution of the service node fails.

When the exporter detects a compensation activity, it accesses the appropriate pattern mapping. In the preferred embodiment, the pattern mapping includes a <compensationHandler> structure. The activity nested within the <compensationHandler> structure will run to compensate an execution failure. The exporter first creates a <compensationHandler> structure, then the compensation activity is mapped to the appropriate activity according to the mappings described in this invention. The resulting activity is nested within the <compensationHandler> structure. For example, the compensation service defined for a service node is mapped to an <invoke> enclosed in a <compensationHandler> tag.

In FIG. 7, a compensation service is shown defined for node RRROp 102.

An example of how a process such as that shown in FIG. 7 is converted by the exporter to a structural text-based representation is shown in the following BPEL4WS segment:

<!-- from BPEL4WS file -->
<invoke inputContainer=“rRRInputMsg” name=“RRROp”
operation=“RRROp”
outputContainer=“rRROutputMsg” portType=“ns3:RRRPortType”>

<compensationHandler>

<invoke inputContainer=“rRRInputMsg”
operation=“EEEOp”
portType=“ns4:EEEPortType”/>

</compensationHandler>

</invoke>

An <invoke> activity RRROp represents node RRROp 102. The <invoke> activity with the operation EEEOp in the <compensationHandler> is the corresponding compensation defined. To conform to the graphical representation, the inputContainer for the compensation activity is always the input of the activity being compensated.

(9) Correlation: Correlations are used in conjunction with input and receive event activities in a run-time system where multiple instances of the same process are running simultaneously. It is used to ensure that events received by the system are directed to the correct process instance. Correlations are set in methods associated with the input and receive event nodes in the process. These methods specify the data to be used as the correlation ID. When the run-time system receives an event with a correlation ID set, the system will direct this event to the correct process instance with the same correlation ID.

When a correlation in the graphical representation is identified, the exporter accesses the appropriate pattern mapping. In the preferred embodiment, a <correlation> element is included in for the pattern mapping.

To use <correlation> in BPEL4WS, a correlation ID must be first defined in the BPEL4WS process. It is referenced by a <correlationset> element. A<correlation> structure is then created and nested within the <receive> activity, which corresponds to the input node, and the <onMessage> structure of the <pick> activity, which corresponds to the receive event nodes in the graphical representation. The <correlation> structure references the <correlationset> element in order to specify which correlation ID is used.

FIG. 8 shows a graphical representation having input node 112 and receive event node 114. An example illustrating the conversion of the process shown in FIG. 8 to a structural text-based representation is set out in the following segment:

<!-- from BPEL4WS file -->
<correlationSets>

<correlationSet name=“correlationIDSet”
properties=“ns1:correlationID”/>

</correlationSets>
<sequence>

<receive container=“input” createInstance=“yes”
operation=“YYYOp”
portType=“ns2:YYYPortType”>
<correlations>

<correlation initiation=“yes” pattern=“in”
set=“correlationIDSet”/>

</correlations>
</receive>
<pick createInstance=“no” name=“Event”>

<onMessage container=“message1” operation=“OneWayOp1”
portType=“ns3:OneWayOpPT”>

<correlations>

<correlation initiation=“no”
pattern=“in”
set=“correlationIDSet”/>

</correlations>
<invoke inputContainer=“output”
name=“Output_Output”
operation=“ZZZOneWayOp”
portType=“ns4:ZZZPortType”/>

</onMessage>

</pick>

</sequence>

Referring to FIG. 8, an assumption of the preferred embodiment is that if a correlation is defined for receive event node 114, a correlation is also defined for the process level input node 112 because it is assumed that the value of the correlation is initiated at the start of the process. If one or more getCorrelationId methods are provided by the user for input nodes or receive event nodes, a <correlationSet> named correlationIDSet is generated in the BPEL4WS <process> and a bpws: property named correlationID is generated in the definitions file. Implementations may have only one correlationSet defined for each <process>. It refers to the property called correlationID. The property is defined in the definitions file and is shown here:
<bpws:property name=“correlationID” type=“xsd:string”/>

For an input node and out terminals of receive event nodes that have a getCorrelationId method defined, a <correlation> structure is defined for the <receive> activity and <onMessage> structure. The <correlation> structures refer to the same <correlationSet> named correlationIDSet. The <correlation> structures are generated with the attribute pattern equal to in. The <correlation> for the <receive> activity has the attribute initiation equal to yes which initiates the value of the property named correlationID. The <correlation> for <onMessage> structures set the attribute initiation equal to no.

In the preferred embodiment, the WSADIE code that defines the correlation for input nodes and receive event nodes follows the pattern below:

correlationID =
message.getPartName( ).getChild1Name( ).getChild2Name( )....

The message in the above code is the input of the getCorrelationId method associated with the input nodes or the receive event nodes. The above code pattern will be translated to the preferred embodiment of the structural text-based representation using a <bpws:propertyAlias> element in the definition file to specify that the part or children of the part (if the part is a complex type) is used as the value for the correlation ID. Further, <bpws:propertyAlias> has an attribute called messageType. This is set to the type of the input parameter called message of the getCorrelationId method. In addition, <bpws:propertyAlias> has an attribute called part and this is set to the Part Name in the code. With respect to the above pattern, it is determined from the getPartName ( ) portion. Finally, <bpws:propertyAlias> has an attribute called query which specifies where in the message to retrieve the value to be returned for the correlation ID. This is set to an XPath expression that looks like the following:
query=“/Part Name/Child1Name/Child2Name/ . . . ”

With reference to the above pattern, Part Name is determined from the getPartName ( ) portion, Child1Name from the getChild1Name ( ) portion, Child2Name from the getChild2Name ( ) portion and so on.

For the method getcorrelationIdYYYInputMsg, the exporter retrieves the type of message to get the message type, and from getYyyInput ( ), the exporter retrieves the part. Since the part is not a complex type, the query is simply the Part Name. If the part is a complex type, the query is built from the part and children of the part.

An example, shown below, is the <propertyAlias> built for the getCorrelationIdMessage1 method where the part is a complex type. On import, the message type, part and query string must refer to appropriate message and XSD types since the <propertyAlias> will be imported in the same pattern for the user code shown below, including a try/catch block to handle any exceptions that might be thrown.

public static String getCorrelationIdYYYMsg(

com.yyy.www_msg.YYYInputMsgMessage message)
throws com.ibm.bpe.api.ProcessException {
String correlationID = null;
// user code begin {Correlation ID Expression}
try {

correlationID = message.getYYYInput( );

} catch (Exception e) {
}
// user code end
return correlationID;

}
<!-- from BPEL4WS definitions file -->
<bpws:propertyAlias messageType=“ns2:YYYInputMsg”
part=“YyyInput”
propertyName=“ns3:correlationID” query=“/YyyInput”/>
public static String get CorrelationIdMessage1{

com.onewayop_msg.Message1Message message)
throws com.ibm.bpe.api.ProcessException {
String correlationID = null;
// user code begin {Correlation ID Expression}
try {

correlationID = message getComplex( ).getComplexName( );

} catch (Exception e) {
}
// user code end
return correlationID;

}
<!-- from BPEL4WS definitions file -->
<bpws:propertyAlias messageType=“ns0:Message1” part=“Complex”
propertyName=“ns3:correlationID” query=“/Complex/ComplexName”/>

(10) Variables: Variables are defined to store data used by other nodes in the process. In a graphical representation of a business process in the preferred embodiment, a variable type is defined by a Web Services Description Language (WSDL) message.

When the exporter identifies a variable in the graphical representation, it accesses the corresponding pattern mapping. In the preferred embodiment, variables correspond to BPEL4WS <container> elements. The container type is defined by the same WSDL message as the variable.

The following table represents a variable page in the process tool, which defines variables in the process:

| Name | Message Type | Description |
|---|---|---|
| input | TTTInputMsg | User defined container |
| output | TTTOutputMsg | User defined container |
| aAAInputMsg | AAAInputMsg | User defined container |
| rRRInputMsg | RRRInputMsg | User defined container |
| rRROutputMsg | RRROutputMsg | User defined container |
| tTTInputMsg | TTTInputMsg | User defined container |
| tTTOutputMsg | TTTOutputMsg | User defined container |

The above variables in the process tool are mapped to the business process language as follows:

<!-- from BPEL4WS file -->
<containers>

<container messageType=“ns2:TTTInputMsg”
name=“input”/>
<container messageType=“ns2:TTTOutputMsg”
name=“output”/>
<container messageType=“ns3:AAAInputMsg”
name=“aAAInputMsg”/>
<container messageType=“ns3:AAAOutputMsg”
name=“aAAOutputMsg”/>
<container messageType=“ns4:RRRInputMsg”
name=“rRRInputMsg”/>
<container messageType=“ns4:RRROutputMsg”
name=“rRROutputMsg”/>
<container messageType=“ns2:TTTInputMsg”
name=“tTTInputMsg”/>
<container messageType=“ns2:TTTOutputMsg”
name=“tTTOutputMsg”/>

</containers>

(11) Fault Handling: In the preferred embodiment, for a graphical representation of a business process, a service node, loop node or block node may throw an exception, represented by a fault terminal on the node. Each fault terminal represents a fault that could be thrown by the node.

The fault terminals each have an associated connection element. The path directed from a fault terminal defines how the process reacts if a fault is caught. An exception can be caught and thrown again. If the exception is thrown internally from a loop or a block body, then the parent element, i.e. the element whose body contains this loop or block node, should handle this exception. If the exception is thrown externally from the root process composition, then the process caller should handle the exception. In the preferred embodiment, handling of an exception is modelled using a fault node.

When a fault situation is detected by the exporter, the corresponding pattern mapping is accessed. In the preferred embodiment, the mapping uses a <catch> structure to correspond to the fault terminal. A <catch> structure has an attribute faultName. It defines the fault the <catch> structure should handle. All elements in the fault path are converted according to the mappings described in the invention. The resulting structure is nested within the <catch> structure. The container attribute of the <catch> structure represents the variable assigned to the fault terminal. Embedded in the <catch> are the activities that execute when the fault is caught. These represent the nodes that run following the control connections from a fault terminal of a node.

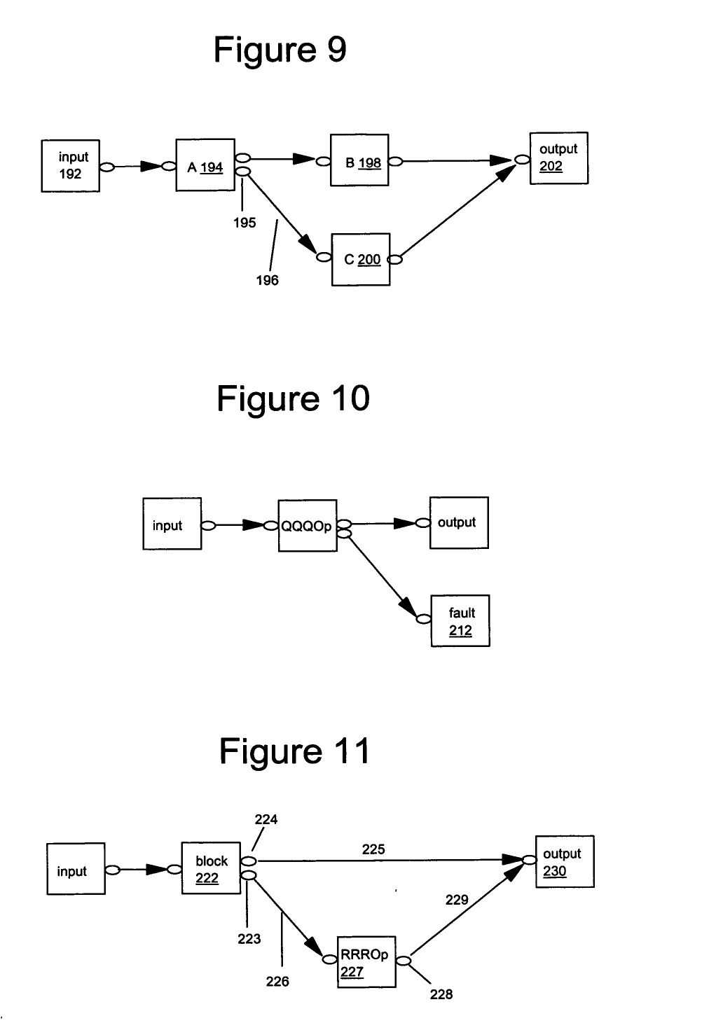

Referring to FIG. 9, service node A 194 has fault terminal 195. An example illustrating the conversion of the process represented in FIG. 9 to a structural text-based language is as follows:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3”/>
<link name=“FlowConditionalControlConnection_4”/>

</links>
<receive container=“input” createInstance=“yes”
operation=“TTTProcessOp” portType=“ns2:TTTPortType”>

<source linkName=“FlowConditionalControlConnection_1”/>

</receive>

<invoke inputContainer=“vVVInputMsg” name=“A” operation=“VVVOp”
outputContainer=“vVVOutputMsg” portType=“ns3:VVVPortType”>

<target linkName=“FlowConditionalControlConnection_1”/>
<source linkName=“FlowConditionalControlConnection_2”/>
<catch faultContainer=“vVVFaultMsg” faultName=“ns3:vvvFault”>

<invoke inputContainer=“rRRInputMsg” name=“C” operation=“RRROp”
outputContainer=“rRROutputMsg” portType=“ns5:RRRPortType”>

<source linkName=“FlowConditionalControlConnection_3”/>

</invoke >

</catch>

</invoke>
<invoke inputContainer=“aAAInputMsg” name=“B” operation=“AAAOp”
outputContainer=“aAAOutputMsg” portType=“ns4:AAAPortType”>

<source linkName=“FlowConditionalControlConnection_4”/>
<target linkName=“FlowConditionalControlConnection_2”/>

</invoke>

<reply container=“output” operation=“TTTProcessOp”
portType=“ns2:TTTPortType”>

<target linkName=“FlowConditionalControlConnection_3”/>
<target linkName=“FlowConditionalControlConnection_4”/>

</reply>

</flow>

The attribute suppressJoinFailure must be set equal to yes in the <process> element in which this code example is nested. The <receive> activity, the <invoke> activity A, and the <invoke> activity B represent input node 192 to node A 194 to node B 198. The <invoke> activity A has a <catch> structure specifying the fault name and container. The <catch> structure contains the <invoke> activity C representing control connection 196 from fault terminal 195 on node A 194 to node C 200.

When a fault is caught for node A 194, node C 200 will run followed by output node 202. Node B 198 will not run. In the example provided above, if a fault is caught for the <invoke> activity A, activity A is halted as a result of the fault which then results in all outgoing links being set to negative. Consequently, the join condition at activity B is evaluated to false since it is the target of the link source <source linkName=“FlowConditionalControl Connection_{—}2”>/, and this activity is skipped. The inline fault handler mapping for <invoke> is the only mapping supported by the tool of the preferred embodiment.

When a fault may be thown more than once, it is mapped to different activities depending on whether the exporter determines that the exception is thrown internally or externally. If the fault is thrown internally, i.e. the fault node is in the loop or block body, this fault node will be represented by a <throw> activity in the preferred embodiment. If the fault is thrown externally, i.e. the fault node is in the root process composition, if the process is synchronous, this fault node will be modelled as a <reply> activity in the preferred embodiment. If the process is asynchronous, this fault node will be modelled as an <invoke> activity instead.

When the fault is thrown internally in a block or a loop body, in the preferred embodiment, the exporter applies a mapping in which a <throw> activity is used to represent the fault node. A <faultHandlers> element is put inside the <scope> activity of the block. For each fault terminal, there is a <catch> structure inside the <faultHandlers> element. The <catch> structure shows the fault path from the fault terminal. The faultName attribute of the <catch> element is set to the qualified message type of the fault being caught.

An example illustrating the use of a <throw> activity in the preferred embodiment is as follows:

<!-- from BPEL4WS file -->
<containers>

<container messageType=“ns1:RRRInput” name=“RRRContainer”/>

</containers>
...
<throw faultContainer=”RRRContainer” faultName=”ns1:RRRInput”
name=”InnerFault”/>

FIGS. 10 and 11 provide an illustration of a fault thrown in a block. FIG. 10 shows the body of a block with a fault node 212. FIG. 11 shows a block node 222 with a fault terminal 223, the body of the block being that shown in FIG. 10.

An example illustrating a conversion of the graphical representation of the process shown in FIG. 11 is as follows:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3”/>

</links>
<receive container=“input” createInstance=“yes”
operation=“TTTProcessOp” portType=“ns2:TTTPortType”>

<source linkName=“FlowConditionControlConnection_1”/>

</receive>
<scope containerAccessSerializable=“no” name=“Block”>

<faultHandlers>

<catch faultName=“ns3:QQQFaultMsg” >

<invoke inputContainer=“rRRInputMsg” name=“RRROp”
operation=“RRROp” outputContainer=“rRROutputMsg”
portType=“ns4:RRRPortType”>

<source
linkName=“FlowConditionalControlConnection_3”/>

</invoke>

</catch>

</faultHandlers>
<sequence>

<target linkName=”FlowConditionalControlConnection_1”/>
<source linkName=“FlowConditionalControlConnection_2”/>
<empty name=“Input_Input”/>
<invoke inputContainer=“qQQInputMsg” name=“QQQOp”
operation=“QQQOp” outputContainer=“qQQOutputMsg”
portType=“ns3:QQQPortType”>

<catch faultContainer=“qQQFaultMsg”
faultName=“ns3:qqqFault”>

<throw faultContainer=“fault”
faultName=“ns3:QQQFaultMsg” name=“Fault”/>

</catch>

</invoke>
<empty name=“Output_Output”/>

</sequence>

</scope>
<reply container=“output” operation=“TTTProcessOp”
portType=“ns2:TTTPortType”>

<target linkName=“FlowConditionalControlConnection_2”/>
<target linkName=“FlowConditionalControlConnection_3”/>

</reply>

</flow>

The example above shows a <scope> within a <flow> activity. Out terminal 228 of service node RRROp 227 is connected to output node 230. The <reply> activity representing output node 230 is placed outside a <sequence> containing the activity represented by block node 222. The link named FlowconditionalControlConnection_{—}2 from the primary activity of the <scope> element to the <reply> element represents control connection 225. For control connection 226 from the fault terminal 223 of the block node 222 to service node 227, the activity representing service node 227 would be placed in the <catch> structure. The <invoke> activity QQQOp, shown in the <scope>, has a <catch> structure. Inside this <catch> is the <throw> activity that represents fault node 212 shown in the block body.

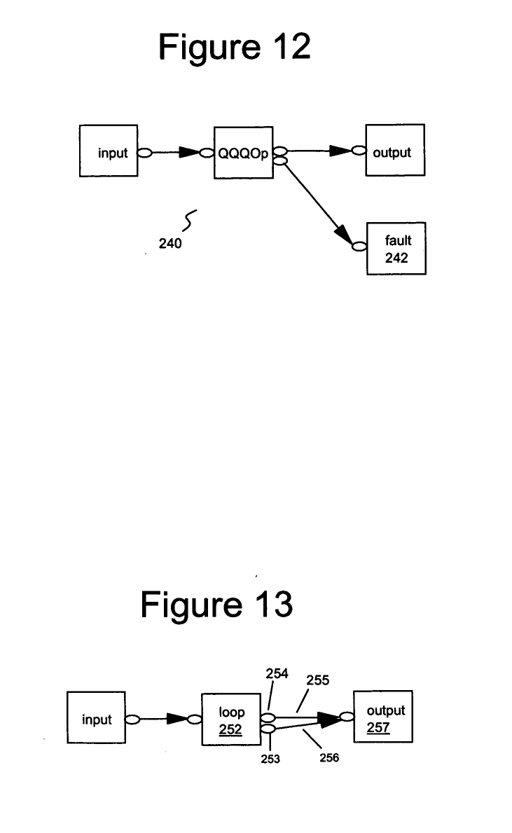

FIGS. 12 and 13 provide an illustration of a fault thrown in a loop. FIG. 12 shows the body of a loop with a fault node 242. FIG. 13 shows a loop node 252 with a fault terminal 253, the body of the loop being that shown in FIG. 12.

An example illustrating a conversion of the graphical representation of the process shown in FIG. 13 is as follows:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3”/>

</links>
<receive container=“input” createInstance=“yes”
operation=“TTTProcessOp” portType=“ns2:TTTPortType”>

<source linkName=“FlowConditionalControlConnection_1”/>

</receive>
<scope containerAccessSerializable=“no”>

<faultHandlers>

<catch faultName=“ns3:QQQFaultMsg”>

<empty>

<source

linkName=“FlowConditionalControlConnection_3”/>

</empty>

</catch>

</faultHandlers>
<while condition=“getInput( ).getTttInput( ).length( ) != 0”

name=“Loop”>

<target linkName=”FlowConditionalControlConnection_1”/>

<source

linkName=“FlowConditionalControlConnection_2”/>
<sequence>

<empty name=“Input_Input”/>
<invoke inputContainer=“qQQInputMsg” name=“QQQOp”
operation=“QQQOp” outputContainer=“qQQOutputMsg”
portType=“ns3:QQQPortType”>

<catch faultContainer=“qQQFaultMsg”
faultName=“ns3:qqqFault”>

<throw faultContainer=“fault”
faultName=“ns3:QQQFaultMsg” name=“Fault”/>

</catch>

</invoke>
<empty name=“Output_Output”/>

</sequence>

</while>

</scope>
<reply container=“output” operation=“TTTProcessOp”
portType=“ns2:TTTPortType”>

<target linkName=“FlowConditionalControlConnection_2”/>
<target linkName=“FlowConditionalControlConnection_3”/>

</reply>

</flow>

The above example shows a <scope> with a <while> activity named Loop. Fault terminal 253 of loop node 252 goes to output node 257. In this particular example, a <reply> activity representing output node 257 is placed outside the outer <scope>. A link, named FlowConditionalControlConnection_{—}2, from the <while> to the <reply> represents control connection 255 from out terminal 254 of loop node 252 to output node 257. For control connection 256 from fault terminal 253 of loop node 252 to output node 257, an <empty> activity with no name is used as placeholder in the <catch> structure. A placeholder is used when the activity it represents cannot be placed within the <catch> structure. The <invoke> activity QQQOP, shown in the <while>, has a <catch> structure. Inside this <catch> is the <throw> activity that represents fault node 242 shown in loop body 240.

(12) Transition Conditions: In the graphical representation of the preferred embodiment, a transition condition determines whether the process modelled in the graph will take a path as specified by the defined transition. The pattern mapping for this feature is to translate the condition to an attribute in the <source> element of a <link> element representing the transition in the structural text-based representation. The transitionCondition attribute of the <source> element is used to specify the condition on a control connection (in the preferred embodiment, a boolean expression in Java). The default condition is true for both BPEL4WS and the graphical representation.

In the preferred embodiment, the name of each <link> element corresponds to the control connection name in the process tool unless it has a condition of otherwise. A condition of otherwise means that if all other connections with the same source node fail (meaning their condition evaluates to false), the control connection that has an otherwise condition set evaluates to true. If the condition on the control connection is otherwise, the <link> name has the following naming convention:
name=[Connection Name]+“_otherwise”

If the condition on the control connection is otherwise, the transitionCondition for the <source> is the NOT of the conditions of all the other control connections OR'ed together (i.e. control connections with the same source). If there is a transition condition present, other links are used to maintain proper semantics. For the transition condition, boolean expressions are placed in quotes and the BPEL4WS transition condition represents the “if” condition in the condition method of the control connection if the condition is set to Java in the process tool. When the code follows a certain format, illustrated below, the exporter may extract the condition correctly. On import, this format is generated and the BPEL4WS transition condition is inserted into the “if” statement. The code on import is also surrounded by a try/catch block to avoid any unhandled exceptions that might be thrown by the Java condition.

public boolean controlCondition_FlowNode2_out_FlowNode6_in( )

throws com.ibm.bpe.api.ProcessException {
boolean result = true;
// user code begin {Condition Expression}
try {

if (getInput( ).getTttInput( ).length( ) != 0)

result = true;

else

result = false;

} catch (Exception e) {
}
// user code end
return result;

}

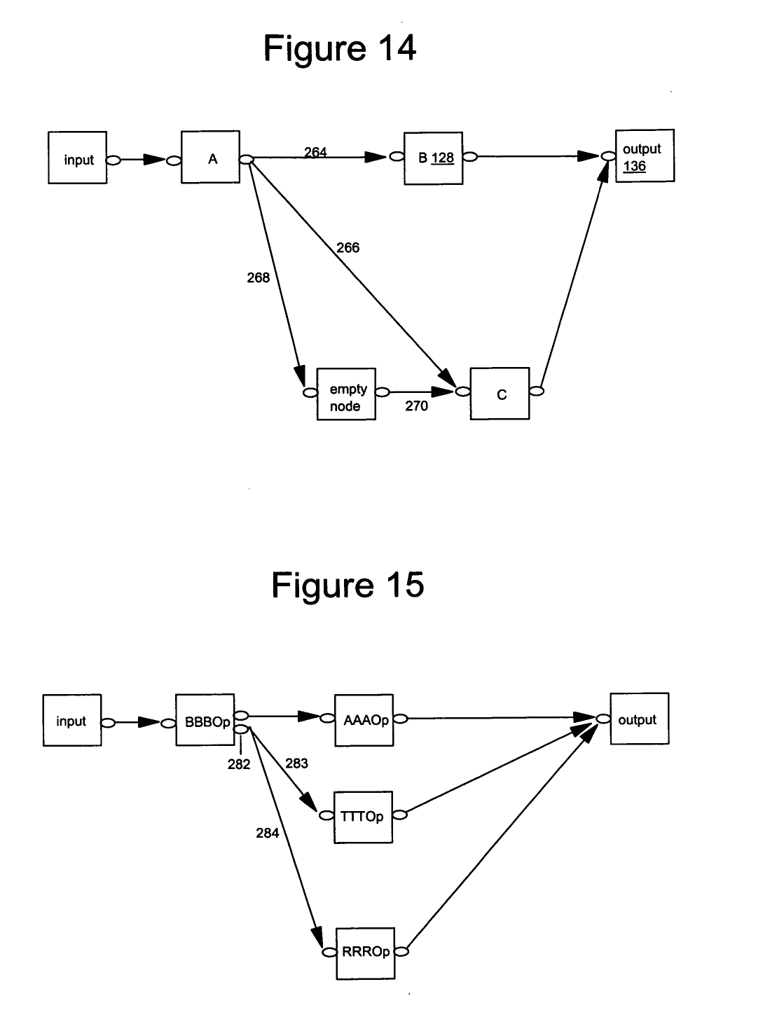

FIG. 14 illustrates a business process containing multiple links with conditions set on them, as it would be displayed in by the graphical representation of the preferred embodiment. An example illustrating a mapping to a structural text-based representation according to the preferred embodiment is as follows:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3_otherwise”/>
<link name=“FlowConditionalControlConnection_4”/>
<link name=“FlowConditionalControlConnection_5”/>
<link name=“FlowConditionalControlConnection_6”/>
<link name=“FlowConditionalControlConnection_7”/>

</links>
<receive container=“input” createInstance=“yes”
operation=“TTTProcessOp” portType=“ns2:TTTPortType”>

<source linkName=“FlowConditionalControlConnection_1”/>

</receive>
<invoke inputContainer=“aAAInputMsg” name=“A” operation=“AAAOp”
outputContainer=“aAAOutputMsg” portType=“ns3:AAAPortType”>

<target linkName=”FlowConditionalControlConnection_1”/>
<source linkName=“FlowConditionalControlConnection_2”
transitionCondition=“getInput( ).getTttInput( ).length( ) != 0”/>
<source linkName=“FlowConditionalControlConnection_3_otherwise”
transitionCondition=“!(false ||
getInput( ).getTttInput( ).length( ) != 0)”/>
<source linkName=“FlowConditionalControlConnection_4”
transitionCondition=“false”/>

</invoke>
<invoke inputContainer=“rRRInputMsg” name=“B” operation=“RRROp”
outputContainer=“rRROutputMsg” portType=“ns4:RRRPortType”>

<source linkName=“FlowConditionalControlConnection_5”/>
<target

linkName=“FlowConditionalControlConnection_3_otherwise”/>

</invoke>
<empty name=“Empty_Empty”>

<source linkName=“FlowConditionalControlConnection_6”
transitionCondition=“false”/>
<target linkName=“FlowConditionalControlConnection_4”/>

</empty>
<invoke inputContainer=“tTTInputMsg” name=“C” operation=“TTTOp”
outputContainer=“tTTOutputMsg” portType=“ns2:TTTPortType”>

<source linkName=“FlowConditionalControlConnection_7”/>
<target linkName=“FlowConditionalControlConnection_2”/>
<target linkName=“FlowConditionalControlConnection_6”/>

</invoke>

<reply container=“output” operation=“TTTProcessOp”
portType=“ns2:TTTPortType”>

<target linkName=“FlowConditionalControlConnection_5”/>
<target linkName=“FlowConditionalControlConnection_7”/>

</reply>

</flow>

Referring to FIG. 14, the link representing control connection 264 has its transition condition set equal to otherwise; the link representing control connection 266 has its transition condition set equal to getinput( ).getTttInput( ).length !=0; the link representing control connection 268 has its transition condition set equal to false; and the link representing control connection 270 has its transition condition set equal to false.

When control connections with conditions originate from a fault terminal or a terminal on a receive event node, an <empty> activity is created inside the appropriate <catch> or <onMessage> element to hold the <source> element for the link. In the preferred embodiment, the BPEL4WS specification indicates that <source> elements cannot be placed directly inside <catch> elements and they cannot be placed in the parent <invoke> activity, as the correct path/terminal corresponding to the <invoke> element is associated with the link.

FIG. 15 illustrates the situation described above with a <catch> element involved. An example illustrating the mapping of the business process described in the graphical representation of FIG. 15 is as follows:

<!-- from BPEL4WS file -->
<flow>

<links>

<link name=“FlowConditionalControlConnection_1”/>
<link name=“FlowConditionalControlConnection_2”/>
<link name=“FlowConditionalControlConnection_3_otherwsie”/>
<link name=“FlowConditionalControlConnection_4”/>
<link name=“FlowConditionalControlConnection_5”/>
<link name=“FlowConditionalControlConnection_6”/>
<link name=“FlowConditionalControlConnection_7”/>

</links>
<receive container=“input” createInstance=“yes”

| | |
|---|---|
| operation=“TTTProcessOp” | portType=“ns2:TTTPortType”> |

<source linkName=“FlowConditionalControlConnection_1”/>

</receive>
<invoke inputContainer=“bBBInputMsg” name=“BBBOp” operation=“BBBOp”

outputContainer=“bBBOutputMsg” portType=“ns3:BBBPortType”>

<target linkName=”FlowConditionalControlConnection_1”/>
<source linkName=”FlowConditionalControlConnection_6”/>
<catch faultContainer=“bBBFaultMsg” faultName=“ns3:bbbFault”>

<flow>

<empty>

<source linkName=“FlowConditionalControlConnection_2”

transitionCondition=“getInput( ).getTttInput( ).length( ) &gt;
0”/>

<source

linkName=“FlowConditionalControlConnection_3_otherwise”
transitionCondition=“!(getInput( ).getTttInput( ).length( ) &gt;
0)”/>

</empty>
<invoke inputContainer=“tTTInputMsg” name=“TTTOp”
operation=“TTTOp” outputContainer=“tTTOutputMsg”
portType=“ns2:TTTPortType”>

<source linkName=“FlowConditionalControlConnection_4”/>
<target linkName=“FlowConditionalControlConnection_2”/>

</invoke>
<invoke inputContainer=“rRRInputMsg” name=“RRROp”
operation=“RRROp” outputContainer=“rRROutputMsg”
portType=“ns5:RRRPortType”>

<source linkName=“FlowConditionalControlConnection_5”/>
<target

linkName=“FlowConditionalControlConnection_3_otherwise”/>

</invoke>

</flow>
</catch>

</invoke>
<invoke inputContainer=“aAAInputMsg” name=“AAAOp” operation=“AAAOp”
outputContainer=“aAAOutputMsg” portType=“ns4:AAAPortType”>

<source linkName=“FlowConditionalControlConnection_7”/>
<target linkName=“FlowConditionalControlConnection_6”/>

</invoke>
<reply container=“output” operation=“TTTProcessOp”

portType=“ns2:TTTPortType”>

<target linkName=“FlowConditionalControlConnection_4”/>
<target linkName=“FlowConditionalControlConnection_5”/>
<target linkName=“FlowConditionalControlConnection_7”/>

</reply>

</flow>

Referring to FIG. 15, an <empty> element is generated in the <catch> element to hold the two <source> elements required to describe two control connections 283, 284 (link names FlowConditionalControlConnection_{—}2 and FlowConditionalControlConnection_{—}3, respectively) with transition conditions coming from the fault terminal 282. The link representing control connection 283 has its transition condition equal to getInput( ).getTttInput( ).length>0 and the link representing control connection 284 has its transition condition equal to otherwise. If no fault is thrown in the above example, then the process will flow through the link FlowconditionalControlConnection_{—}6. As discussed above, the attribute suppressJoinFailure is set equal to yes in the <process> element in which this code example is nested.

To summarize, the following table sets out features and their associated pattern mappings. As described above, when converting from graphical to structural text-based representations, features as set out in the table are identified in the graphical representations and the associated pattern mappings are used to define equivalent code in a structural text-based language:

| Feature | Pattern Mapping |
|---|---|
| synchronous/ | a synchronous process is represented as having a |
| asynchronous | <receive> activity as its input interface, and a |
| processes | <reply> activity as its output interface |
| | an asynchronous process is represented as having a |
| | <receive> activity as its input interface, and an |
| | <invoke> activity as its output interface |
| request/response | an <invoke> activity with attributes inputContainer |
| activity | and outputContainer to specify input and output |
| | containers assigned to the activity |
| one-way activity | an <invoke> activity, with attribute inputContainer |
| | (no outputContainer) |
| empty node | an <empty> activity (naming convention to include |
| | node name) |
| block | a <scope> activity (two <empty> activities nested |
| | within the <scope> to represent the input and output |
| | nodes in the block body) |
| iteration | a <while> activity (attribute condition equivalent to |
| | loop condition in loop node; two <empty> activities |
| | nested within the <while> activity to represent input |
| | and output nodes in the loop body). |
| receive event | a <pick> activity (contains <onMessage> structures |
| | to define events accepted by <pick> activity - |
| | corresponding to events defined in the receive event |
| | node) |
| compensation | a <compensationHandler> structure (activity within |
| | the structure will run to compensate an execution |
| | failure) |
| correlation | a <correlation> element (a correlation ID is defined |
| | and referenced by a <correlationSet> element>; the |
| | <correlation> element is nested within a <receive> |
| | activity representing the input node, and within all |
| | <pick> activities corresponding to the receive event |
| | nodes; <correlation> structure references |
| | <correlationSet> element to specify the correlation |
| | ID used) |
| variables | containers |
| fault handling | a <catch> structure (containing elements in the fault |
| | path) if the fault is only thrown once if the fault |
| | can be caught and thrown again then |
| | (a) if thrown internally: a <throw> activity; or |
| | (b) if thrown externally: a <reply> activity |
| transition | an attribute in the <source> element of a <link> |
| condition | element representing the transition |

In addition, as those skilled in the art will appreciate, a structural text-based representation of a business process which is coded so as to conform with the above pattern mapping definitions may be imported to produce a graphical representation of the business process. For such a structural text-based representation to be correctly converted, the representation should be written with reference to the pattern mappings described above. To ensure correct conversion, the text-based representation employs naming conventions such as those set out in the above detailed description to avoid ambiguity or error in the conversion to a graphical representation.

For example, in an asynchronous process, service nodes, output nodes and fault nodes may all be represented by <invoke> activities in BPEL4WS. The importer must therefore evaluate the activity in order to determine the appropriate corresponding feature. If the importer does not determine that the <invoke> activity is an output or a fault node under the naming convention, then the activity is imported as a service node. Similarly, only <empty> activities in the structural text-based representation of the preferred embodiment that follow the naming convention set out above will be imported as empty nodes. Other <empty> activities that do not follow this convention may be present in the text-based representation only as a placeholder. In the preferred embodiment, the exporter will apply these naming conventions when a graphical representation of a business process is converted to a structural, text-based representation, so that a reverse conversion process may be applied when the text-based representation is imported to a graphical process tool.

In the preferred embodiment, the graphical representation supports the use of Java code in several contexts. The structured text-based language referred to in the description of the preferred embodiment supports XPath code. Both Java and XPath code are commonly used and the conversion from graphical to structured text-based representations will also include a corresponding conversion from Java to XPath. For this reason, the preferred embodiment handles the case where the graphical representation references Java code and/or the structural text based representation references XPath code. A description of how certain conversion steps are carried out is set out below:

Java Snippet Nodes: Java snippet nodes are supported in the graphical representations of the preferred embodiment and allow for execution of a piece of Java code written by the users by referencing the code in a Java Snippet Node in the graphical representation.

When the exporter of the preferred embodiment identifies a Java snippet node, it access a corresponding pattern mapping. In the preferred embodiment, the equivalent BPEL4WS representation applied using the pattern mapping includes the BPEL+language extension such that a <wswf:script> activity represents a Java snippet node.

Thus, the process shown in FIG. 3 may be mapped to a structural text-based representation in accordance with the following segment:

<!-- from BPEL4WS file -->
<sequence>

<receive container=“input” createInstance=“yes” operation=“RRROp”
portType=“ns2:RRRPortType”/>
<empty name=“Empty_NodeA”/>
<wswf:script name=“JavaSnippet” wswf:language=“Java”>
getOutput( ).setRrrOutput(getInput( ).getRrrInput( )); </wswf:script>
<reply container=“output” operation=“RRROp”
portType=“ns2:RRRPortType”/>

</sequence>

A <wswf:script> activity corresponding to a Java snippet node such as the Java

snippet node 34 has the following pattern:

name = [Name of Java Snippet node]
wswf:language=“Java”

The Java content between the user code begin and end strings from the method body of the Java snippet node is placed in between the <wswf:script> start and end tags. In this manner, the Java code in a Java Snippet Node in the graphical representation may be represented in the structural text-based representation.

Assignment and Condition Expressions: Java expressions used for assignments and condition evaluations are translated to corresponding XPath expressions, and they are set on the corresponding elements in the business process language.

A pattern conversion from a Java snippet node to a <wswf:script> activity is described as an extension to the BPEL4WS standard. In some cases, if the piece of Java code performs an assignment operation, the Java snippet node can be represented as an <assign> activity in the equivalent BPEL4WS representation. The conversion using an <assign> activity is useful if the resulting BPEL4WS documents are used in situations where BPEL Extensions elements are not supported.

Additionally, when converting from a business process language representation to a process graph-based representation, XPath expressions are translated to Java codes and assigned to the corresponding elements in the process graph-based representation.

Assignments: An assignment is specified in a language such as Java. In the graphical representation of the preferred embodiment, an assignment is specified in Java and enclosed in a Java snippet node.

Assignment code in a Java snippet node, corresponding to a variable assignment, is mapped to an <assign> activity in BPEL4WS. The Java code is mapped to XPath as specified in BPELAWS. Several, but not all, assignment code patterns are supported in this mapping.

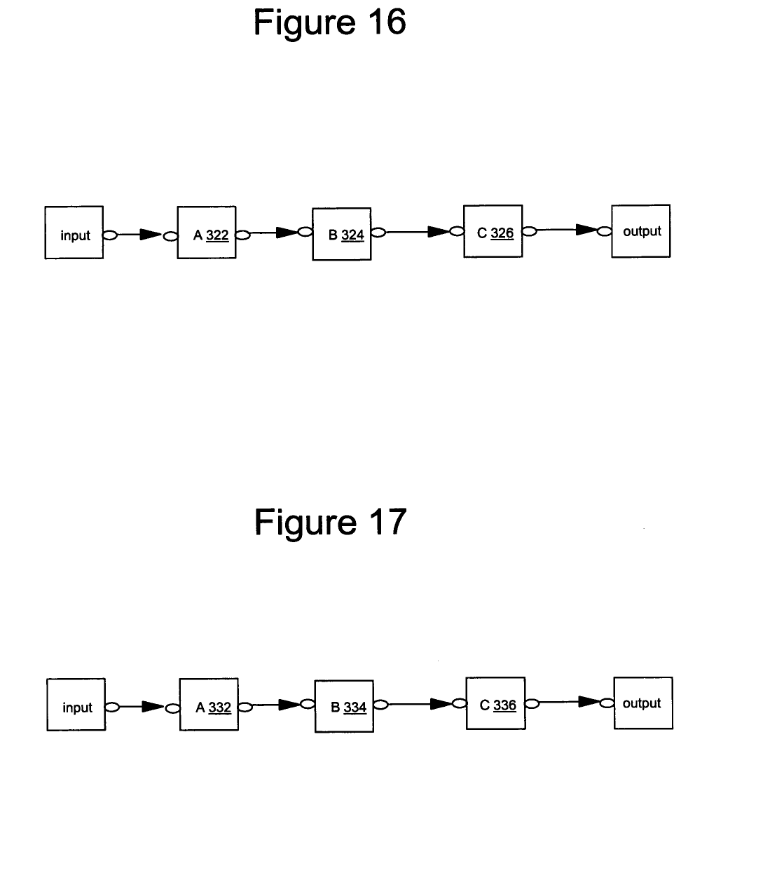

FIG. 16 illustrates a simple process, containing multiple Java snippet nodes with assignment code set on them. There are two variables, InputMsg and OutputMsg, defined in this process. They both contain two part elements, StringPart and intPart. Node A 322 has assignment code getOutMsg( ).setStringPart (“string”); node B 324 has assignment code getoutMsg( ).setIntPart (1000); node C 326 has assignment code getOutputMsg( ).getStringPart(getInputMsg( ).getStringPart( )).

An example of the mapping of the process shown in FIG. 16 to a text-based structural representation in accordance with the preferred embodiment is as follows:

<!-- from BPEL4WS file -->
<sequence>
<receive container=“InputMsg” createInstance=“yes”

operation=“ZZZProcessOp” portType=“ns3:ZZZPortType”/>

<assign name=“A”>
<copy>
<from expression=“‘string’”/>
<to container=“OutputMsg” part=“StringPart”/>
</copy>
</assign>
<assign name=“B”>
<copy>
<from expression=“number(1000)”/>
<to container=“OutputMsg” part=“IntPart”/>
</copy>
</assign>
<assign name=“C”>
<copy>
<from container=“InputMsg” part=“StringPart”/>

<to container=“OutputMsg” part=“StringPart”/>

</copy>
</assign>
<reply container=“OutputMsg” operation=“ZZZProcessOp”

portType=“ns3:ZZZPortType”/>

For Java snippet nodes, an <assign> activity assigns data to and from a variable. In this case, an <assign> activity is generated for Java snippet nodes. It has the following pattern:
name=[Name of the Java snippet node]

Each Java snippet node must contain exactly one line of code that follows a certain format in order for the exporter to extract and convert it correctly. In the preferred embodiment there are three formats supported by the exporter, which are described below. Each variable defined in the process is generated to a Java backing class. This class contains the getter and setter methods to allow users to manipulate the data of that variable.

Code pattern 1 has the following format:
getVariableName( ).setPartName(“literal string”);

The code assigns a literal string to a part of a variable. VariableName is the name of the variable involved in the assignment. Note that this variable is defined in the process. Part Name is the name of the part defined in the specified variable. It is of string type. Note that this part exists in the message type defined for the variable. The literal string is surrounded by quotations.

In the preferred embodiment, an example of the translation of Java snippet nodes with code written in the above format is the following:

<assign><copy>
<from expression=“‘literal string’”/>
<to container=“VariableName” part=“PartName”/>
</copy></assign>

The <from> construct defines the source of the assignment. In this case, it is a literal string. The <to> construct defines the target of the assignment. It has attributes container and part to specify where the data should be assigned.

Code pattern 2 has the following format:
getVariableName( ).setPartName(integer);

The code assigns an integer value to a part of a variable. VariableName is the name of the variable involved in the assignment. Note that this variable is defined in the process. PartName is the name of the part defined in the specified variable. It is of integer type. Note that this part exists in the message type defined for the variable.

In the preferred embodiment, an example of the translation of Java snippet nodes with code written in the second format is the following:

<assign><copy>
<from expression=“number(integer)”/>
<to container=“VariableName” part=“PartName”/>
</copy></assign>

The <from> construct defines the source of the assignment. In this case, it is an integer. It uses a built-in function number( ) for the conversion, since every attribute is interpreted as a string in BPEL4WS document. The <to> construct defines the target of the assignment. It has attributes container and part to specify where the data should be assigned.

Code pattern 3 has the following format:
getvariablelName( ).setPart1Name(getvariable2Name( ).getPart2Name( ));

The code assigns the value of a variable part to another variable part. The variable parts is of type integer or string. The source and target variable part are of the same type. Variable1Name is the name of the target variable involved in the assignment. Note that this variable is defined in the process. Variable2Name is the name of the source variable involved in the assignment. Note that this variable is defined in the process. Part1Name is the name of the target part whose value is being updated by the assignment. Note that this part exists in the message type defined for the variable. Part2Name is the name of the source part from which the assignment obtains the value. Note that this part exists in the message type defined for the variable.

In the preferred embodiment, an example of the translation of Java snippet nodes with code written in the third format is the following:

<assign><copy>
<from container=“Variable2Name” part=“Part2Name”/>
<to container=“Variable1Name” part=“Part1Name”/>
</copy></assign>

The <from> construct defines the source of the assignment. In this case, it has attributes container and part to specify where the data is located. The <to> construct defines the target of the assignment. It has attributes container and part to specify where the data should be assigned.

Conditions: Conditions include both loop conditions and transition conditions. A loop condition determines whether a loop node should execute, whereas a transition condition determines whether the process should take the path directed by that transition. In the graphical representation of the preferred embodiment, conditions are preferably expressed in Java. In the preferred embodiment in BPEL4WS, conditions are expressed in XPath.

FIG. 17 illustrates a simple process, containing multiple links with conditions set on them, as it would be displayed in the process tool. There are two variables, InputMsg and outputMsg, defined in this process. They both contain two part elements, StringPart and Intpart. The link A to B for control connection 332 has Java condition getInputMsg( ).getStringPart( )==“string”; the link B to C for control connection 334 has Java condition getInputMsg( ).getIntPart( ) !=1000; and the link C to Output for control connection 336 has Java condition getOutputMsg( ).getStringPart ( ) !=getinputMsg( ).getStringPart( ). In the following BPEL4WS example, more <link> elements are created than listed above. <link> elements are also created for process execution control reasons other than to describe connection conditions.

An example illustrating the mapping of the process shown in FIG. 17 to a structural text-based language by the exporter in accordance with the preferred embodiment is as follows:

<!-- from BPEL4WS file -->
<flow>
<links>
<link name=“FlowConditionalControlConnection_3”/>
<link name=“FlowConditionalControlConnection_4”/>
<link name=“FlowConditionalControlConnection_5”/>
</links>
<sequence>
<receive container=“InputMsg” createInstance=“yes”

operation=“ZZZProcessOp” portType=“ns3:ZZZPortType”>

<source linkName=“DPELink_receiveToA”/>
</receive>
<invoke inputContainer=“” name=“A” operation=“AAAOp”

portType=“ns2:AAAPortType”>

<source linkName=“FlowConditionalControlConnection_3”

transitionCondition=“bpws:getContainerData(‘InputMsg’,
‘StringPart’)=‘string’”/>

</invoke>
<invoke inputContainer=“” name=“B” operation=“RRROp”

portType=“ns2:RRRPortType”>

<source linkName=“FlowConditionalControlConnection_4”

transitionCondition=“bpws:getContainerData(‘InputMsg’,
‘IntPart’)!=1000”/>

<target linkName=“FlowConditionalControlConnection_3”/>
</invoke>
<invoke inputContainer=“” name=“C” operation=“TTTOp”

portType=“ns2:TTTPortType”>

<source linkName=“FlowConditionalControlConnection_5”

transitionCondition=“bpws:getContainerData(‘OutputMsg’,
‘StringPart’)!=bpws:getContainerData(‘InputMsg’, ‘StringPart’)”/>

<target linkName=“FlowConditionalControlConnection_4”/>
</invoke>
<reply container=“OutputMsg” operation=“ZZZProcessOp”

portType=“ns3:ZZZPortType”>

<target linkName=“FlowConditionalControlConnection_5”/>
</reply>
</sequence>
</flow>

The mapping involves translating the condition expressed in Java to that expressed in XPath, and assigning the resulting expression to the corresponding element. A transition condition is saved as an attribute in the <source> element of the <link> element that represents the transition. A loop condition is saved as an attribute of a <while> activity as detailed under “Iterations.”

For a transition condition, the required elements are generated as described. For a loop condition, a <while> corresponding to a loop node must be generated. The code must follow certain formats in order for the exporter to extract and convert the condition correctly. Currently, there are three formats that are supported by the exporter, which are illustrated below. Each variable defined in the process is generated to a Java backing class. This class contains the getter and setter methods to allow users to manipulate the data of that variable.

Condition pattern 1 has the following format:
getvariableName( ).getPartName( )==“literal string”

The condition compares a part of a variable to a literal string on the right. VariableName is the name of the variable involved in the condition evaluation. This variable is defined in the process. Part Name is the name of the part defined in the specified variable. It is of string type. This part must exist in the message type defined for the variable. The sign ==defines the evaluation operation. The sign !=is also supported in this mapping. The literal string must be surrounded by quotations.

In the preferred embodiment, an example of the translation of the above condition pattern is the following:

bpws:getContainerData(‘VariableName’, ‘PartName’) == ‘literal
string’

The above XPath condition uses a BPEL built-in function, bpws:getContainerData( ), to extract data from a variable. Then the condition is evaluated by comparing the result to the literal string.

Condition pattern 2 has the following format:
getVariableName( ).getPartName( )==integer

The condition compares a part of a variable to integer on the right. VariableName is the name of the variable involved in the condition evaluation. This variable is defined in the process. Part Name is the name of the part defined in the specified variable. It is of integer type. This part exists in the message type defined for the variable. The sign ==defines the evaluation operation. Other symbols such as !=, <, >=and <=are also supported in this mapping.

In the preferred embodiment, an example of the translation of the second condition pattern is the following:
bpws:getContainerData(‘VariableName’, ‘PartName’)==integer

The above XPath condition uses a BPEL built-in function, bpws:getContainerData( ), to extract data from a variable. Then the condition is evaluated by comparing the result to the integer.

Condition pattern 3 has the following format:

getVariable1Name( ).getPart1Name( ) ==

getVariable2Name( ).getPart2Name( )

The condition compares a part of a variable to a part of another variable. The variable parts are of type integer or string. The source and target variable parts are of the same type. Variable1Name and Variable2Name are the names of the variables involved in the condition evaluation. These variables are defined in the process. Part1Name and Part2Name are the names of the part defined in the specified variable. This part exists in the message type defined for the variable. The sign ==defines the evaluation operation. Other symbols are also supported depending on the type. If both sides are of string type, !=is supported. If both are of integer type, symbols such as !=, <, >, <=and >=are also supported.

In the preferred embodiment, an example of the translation of the third condition pattern is the following:

bpws:getContainerData(‘Variable1Name', ’Part1Name’) ==

bpws:getContainerData(‘Variable2Name’, ‘Part2Name’)

The above XPath condition uses a BPEL built-in function, bpws:getContainerData( ), to extract data from variables. Then the condition is evaluated by comparing the results.

As may be seen from the above description, in the preferred embodiment conversion is supported between a graphical representation supporting Java and a structural text-based representation supporting XPath.

As the preferred embodiment of the present invention has been described in detail by way of example, it will be apparent to those skilled in the art that variations and modifications may be made without departing from the invention. The invention includes all such variations and modifications as fall within the scope of the appended claims.

1. A computer program product for converting between graphical and structural text-based representations of business processes, the computer program product comprising a computer usable medium having computer readable program code means embodied in said medium, and comprising
computer readable program code means for storing and maintaining a set of features identifiable in graphical business process representations, each feature in the set of features having an associated pattern mapping defined relative to structural text-based representations,
computer readable program code means for identifying portions of an initial graphical representation as matching features in the set of features,
computer readable program code means for generating structural text-based representations of the identified portions of the initial graphical representation by applying the pattern mappings associated with the matching features to the identified portions of the graph-based representation,
computer readable program code means for identifying portions of an initial structural text-based representation of a business process as corresponding to pattern mappings associated with features in the set of features, and
computer readable program code means for generating graphical representations of the identified portions of the initial structural text-based representation by reference to the features associated with the pattern mappings corresponding to the identified portions of the initial structural text-based representation.

2. The computer program product of claim 1, in which the set of identifiable features comprises features selected from: synchronous and asynchronous processes, request/response activities, one-way activities, empty nodes, blocks, iterations, receive events, compensation, correlation, variables, fault handling and transition conditions.

3. The computer program product of claim 2, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationset> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

4. The computer program product of claim 2, in which the computer readable program code means for generating structural text-based representations of the identified portions of the initial graph-based representation further comprises means for converting Java code referenced in the initial graphical representation to XPath code in the generated structural text-based representation.

5. The computer program product of claim 4, in which the means for converting Java code to XPath code comprises means for converting Java snippet nodes, and Java assignment and condition expressions.

6. The computer program product of claim 5, in which the initial graphical representation is compatible with the Web Sphere™ Studio Application Developer Integration Edition platform and the generated structural text-based representation is compatible with the Business Process Execution Language for Web Services platform.

7. An import and export tool for exporting from graphical representations of business processes to structural text-based representations and for importing from structural text-based representations of business processes to graphical representations, the import and export tool comprising:
storage and maintenance code for implementing the storage and maintenance of a set of features identifiable in graphical business process representations, each feature in the set of features having an associated pattern mapping defined relative to structural text-based representations,
graph identification code for identifying portions of an initial graphical representation as matching features in the set of features,
export generation code for generating structural text-based representations of the identified portions of the initial graphical representation by applying the pattern mappings associated with the matching features to the identified portions of the graph-based representation,
import identification code for identifying portions of an initial structural text-based representation of a business process as corresponding to pattern mappings associated with features in the set of features, and
import generation code for generating graphical representations of the identified portions of the initial structural text-based representation by reference to the features associated with the pattern mappings corresponding to the identified portions of the initial structural text-based representation.

8. The import and export tool of claim 7, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationSet> element;
the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

9. The import and export tool of claim 7, in which the export generation code comprises conversion code for converting Java code referenced in the initial graphical representation to XPath code in the generated structural text-based representation.

10. A computer program product for converting from a graphical to a structural text-based representation of business processes, the computer program product comprising a computer usable medium having computer readable program code means embodied in said medium, and comprising
computer readable program code means for storing and maintaining a set of features identifiable in graphical business process representations, each feature in the set of features having an associated pattern mapping defined relative to structural text-based representations,
computer readable program code means for identifying portions of an initial graphical representation as matching features in the set of features, and
computer readable program code means for generating structural text-based representations of the identified portions of the initial graphical representation by applying the pattern mappings associated with the matching features to the identified portions of the graph-based representation.

11. The computer program product of claim 10, in which the computer readable program code means for generating structural text-based representations of the identified portions of the initial graph-based representation further comprises means for extracting properties from graphical elements in the identified portions of the initial graph-based representation and defining corresponding attributes for elements in the generated structural text based representations.

12. The computer program product of claim 11, in which the set of identifiable features comprises features selected from: synchronous and asynchronous processes, request/response activities, one-way activities, empty nodes, blocks, iterations, receive events, compensation, correlation, variables, fault handling and transition conditions.

13. The computer program product of claim 10, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationSet> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

14. The computer program product of claim 12, in which the computer readable program code means for generating structural text-based representations of the identified portions of the initial graph-based representation further comprises means for converting Java code referenced in the initial graphical representation to XPath code in the generated structural text-based representation.

15. The computer program product of claim 14, in which the means for converting Java code to XPath code comprises means for converting Java snippet nodes, and Java assignment and condition expressions.

16. The computer program product of claim 15, in which the initial graphical representation is compatible with the Web Sphere™ Studio Application Developer Integration Edition platform and the generated structural text-based representation is compatible with the Business Process Execution Language for Web Services platform.

17. An export tool for exporting from graphical representations of business processes to structural text-based representations, the export tool comprising:
storage and maintenance code for implementing the storage and maintenance of a set of features identifiable in graphical business process representations, each feature in the set of features having an associated pattern mapping defined relative to structural text-based representations,
graph identification code for identifying portions of an initial graphical representation as matching features in the set of features, and
export generation code for generating structural text-based representations of the identified portions of the initial graphical representation by applying the pattern mappings associated with the matching features to the identified portions of the graph-based representation.

18. The export tool of claim 17, in which the set of identifiable features comprises features selected from: synchronous and asynchronous processes, request/response activities, one-way activities, empty nodes, blocks, iterations, receive events, compensation, correlation, variables, fault handling and transition conditions.

19. The export tool of claim 18, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationset> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

20. The export tool of claim 17, in which the export generation code comprises conversion code for converting Java code referenced in the initial graphical representation to XPath code in the generated structural text-based representation.

21. An import tool for importing from structural text-based representations of business processes to graphical representations, the import tool comprising:
storage and maintenance code for implementing the storage and maintenance of a set of features identifiable in graphical business process representations, each feature in the set of features having an associated pattern mapping defined relative to structural text-based representations,
import identification code for identifying portions of an initial structural text-based representation of a business process as corresponding to pattern mappings associated with features in the set of features, and
import generation code for generating graphical representations of the identified portions of the initial structural text-based representation by reference to the features associated with the pattern mappings corresponding to the identified portions of the initial structural text-based representation.

22. The import tool of claim 21, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationSet> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

23. A computer implemented method for converting from graphical to structural text-based representations of business processes, the method comprising the steps of:
defining and maintaining a data representation of a set of features identifiable in graphical business process representations, each feature in the set of features having an associated pattern mapping defined relative to structural text-based representations,
identifying portions of an initial graphical representation matching features in the set of features, and
generating structural text-based representations of the identified portions of the initial graphical representation by applying the pattern mappings associated with the matching features to the identified portions of the graph-based representation.

24. The method of claim 23, in which the set of identifiable features comprises features selected from: synchronous and asynchronous processes, request/response activities, one-way activities, empty nodes, blocks, iterations, receive events, compensation, correlation, variables, fault handling and transition conditions.

25. The method of claim 24, in which the set of identifiable features and the associated pattern mappings, comprises feature and pattern mapping pairs selected from the following set of pairs:
i. feature: synchronous/asynchronous processes; pattern mapping: a synchronous process representation comprises a <receive> activity as its input interface, and a <reply> activity as its output interface; an asynchronous process representation comprises a <receive> activity as its input interface, and an <invoke> activity as its output interface;
ii. feature: request/response activity; pattern mapping: an <invoke> activity with attributes inputContainer and outputContainer to specify input and output containers assigned to the activity;
iii. feature: one-way activity; pattern mapping: an <invoke> activity, with attribute inputContainer and no outputContainer;
iv. feature: empty node; pattern mapping: an <empty> activity defined by a naming convention including node name;
v. feature: block; pattern mapping: a <scope> activity with two <empty> activities nested within the <scope> activity to represent the input and output nodes in the block;
vi. feature: iteration; pattern mapping: a <while> activity having an attribute condition equivalent to the loop condition in the loop node of the iteration; two <empty> activities nested within the <while> activity to represent input and output nodes in the loop body of the iteration;
vii. feature: receive event; pattern mapping: a <pick> activity containing <onMessage> structures to define events accepted by the <pick> activity, corresponding to events defined in the receive event;
viii. feature: compensation; pattern mapping: a <compensationHandler> structure comprising an activity within the structure to compensate an execution failure;
ix. feature: correlation; pattern mapping: a <correlation> element having a correlation ID defined and referenced by a <correlationset> element; the <correlation> element being nested within a <receive> activity representing an input node, and within all <pick> activities corresponding to one or more receive event nodes;
x. feature: variables; pattern mapping: containers;
xi. feature: fault handling; pattern mapping: a <catch> structure containing elements in a fault path if the fault is only thrown once; where the fault is capable of being repeatedly caught and thrown then
(a) if thrown internally: a <throw> activity; or
(b) if thrown externally: a <reply> activity; and
xii. feature: transition condition; pattern mapping: an attribute in a <source> element of a <link> element representing the transition;

26. The method of claim 24, in which the step of generating structural text-based representations of the identified portions of the initial graph-based representation further comprises the steps of converting Java code referenced in the initial graphical representation to XPath code in the generated structural text-based representation.

27. The method of claim 26, in which the steps of converting Java code to XPath code comprises the steps of converting Java snippet nodes, and Java assignment and condition expressions.

28. The method of claim 27, in which the initial graphical representation is compatible with the Web Sphere™ Studio Application Developer Integration Edition platform and the generated structural text-based representation is compatible with the Business Process Execution Language for Web Services platform.

29. A computer program product comprising a computer-readable signal-bearing medium, the said medium comprising means for accomplishing the method of claim 23.

30. The computer program product of claim 29 in which the medium is a recordable data storage medium.

31. The computer program product of claim 29 in which the medium is a modulated carrier signal.

32. The computer program product of claim 31 in which the signal is a transmission over a network.

33. The computer program product of claim 32 claim in which network is the Internet.

34. A computer program product comprising a computer-readable signal-bearing transmission over a network, the said product comprising means for accomplishing the method of claim 25.
